(19) United States
(12) Patent Application Publication
(10) Pub. No.: US 2025/0206964 A1
(43) Pub. Date: Jun. 26, 2025

(54) ITEM, SUCH AS A TIMEPIECE COMPONENT, COMPRISING A SUBSTRATE AND A VISIBLE LIGHT-ABSORBING COATING

(71) Applicant: The Swatch Group Research and Development Ltd, Marin (CH)

(72) Inventors: Nicolas FRANÇOIS, Neuchâtel (CH); Nathalie Teres, Bôle (CH)

(73) Assignee: The Swatch Group Research and Development Ltd, Marin (CH)

(21) Appl. No.: 18/938,891

(22) Filed: Nov. 6, 2024

(30) Foreign Application Priority Data
Dec. 20, 2023 (EP) 23218890.4

(51) Int. Cl. C09D 5/32; C08K 3/04; C09D 7/40; G04B 19/12; G04B 45/00

(52) U.S. Cl. CPC C09D 5/32; C09D 7/70; G04B 19/12; G04B 45/0015; C08K 3/04

(57) ABSTRACT

An item (10) including a substrate (1) and a multilayer coating (20) deposited on the substrate (1), the multilayer coating (20) being formed by combining a plurality of layers (21, 22, 23, 24) including a binder and pigments, the coating (20) including pigments of different particle sizes.

### CROSS REFERENCE TO RELATED APPLICATIONS

This application claims priority from European Patent Application No. 23218890.4 filed Dec. 20, 2023, the entire contents of which are incorporated herein by reference.

### TECHNICAL FIELD OF THE INVENTION

The field of the invention relates to the surface treatment of items, such as decorative items or timepiece components.

The invention further relates to an item, for example a timepiece component, coated with such a coating that absorbs visible light.

The invention has a particularly interesting application in the field of watchmaking, for the decoration of items or components used in timepieces, for example plates, cocks, bridges, gear trains, screws, oscillating weights, dials, indexes, appliques, aperture discs, hands or any other component of the movement or external component of a timepiece.

### TECHNOLOGICAL BACKGROUND

Coatings that absorb visible light and have a light absorption of over 99.8% exist.

In particular, the Vantablack® coating is known, which is based on carbon nanotubes oriented perpendicularly to the surface of the substrate and pressed against each other. Such a coating gives a black colour with an absorption coefficient of 99.965% of visible light.

However, carbon nanotube-based coatings are very expensive and present health risks, as these particles are known to be carcinogenic, mutagenic or reprotoxic.

Musou® acrylic paint, which is easier to use and apply, has an absorption of up to 99.4% of visible light and a lightness component L* close to 10. However, this coating has the particularity of being very fragile, and gentle contact with the coating can easily lead to peeling of the coating or a deterioration in its absorption. For example, cleaning this type of coating is very difficult without damaging its aesthetic appearance, if dust or fibres have settled thereon. Such a paint is not easily applicable, for example, in the watchmaking industry.

As a result, there is a need to improve these visible light-absorbing coatings so that they can be used on items that can be handled, for example timepiece components, without risk to health and without the risk of the coating being damaged by simple contact with or handling of the item.

### SUMMARY OF THE INVENTION

In this context, the aim of the invention is to provide an item with a coating with very high light absorption, while avoiding the use of carbon nanotubes and/or graphene particles.

To this end, the invention relates to an item comprising a substrate and a multilayer coating deposited on the substrate, the multilayer coating being formed by combining a plurality of layers comprising a binder and pigments, the coating comprising pigments of different particle sizes.

According to the invention, the item coated with the visible light-absorbing decorative coating according to the invention can give a lightness component L* of less than 20 with substrates of various kinds.

In addition to the features mentioned in the preceding paragraph, the item according to the invention can have one or more complementary features from among the following, considered either on an individual basis or according to any combination technically possible:
the multilayer coating comprises pigments of nanometric and micrometric dimensions;
the multilayer coating comprises glass beads;
the multilayer coating comprises an undercoat covering at least a portion of the substrate, the undercoat comprising pigments with a d90 percentile of nanometric dimension;
the multilayer coating comprises a stack of a plurality of successive layers, superimposed on one another, at least partially covering the undercoat, each of the successive layers of the stack comprising pigments with a d90 percentile different from the d90 percentile of the pigments in the layer which it covers;
each of the successive layers in the stack comprises pigments with a d90 percentile greater than the d90 percentile of the pigments in the layer it covers;
each layer n of the stack has pigments with a d90 percentile equivalent to n*k/10 μm, where k is a homothetic factor between the d90 percentile of the pigments in two consecutive layers of the stack;
the multilayer coating comprises a plurality of layers of different particle sizes, which layers are juxtaposed relative to one another and which each cover a predetermined portion of the undercoat;
the pigments in the plurality of layers covering the undercoat are micrometric in size;
the multilayer coating comprises a first layer at least partially covering a first portion of the undercoat and a second layer juxtaposed to the first layer and at least partially covering a second portion of the undercoat, which portion is different from the first portion, the pigments of the second layer having a d90 percentile greater than the d90 percentile of the pigments in the first layer;
the multilayer coating comprises a first layer at least partially covering the undercoat, the first layer comprising pigment agglomerates composed of a mixture of pigments of different particle sizes;
the first layer comprises pigment agglomerates composed of the mixture of pigments having a d90 percentile of nanometric dimension and of pigments having a d90 percentile of micrometric dimension;
the pigment agglomerates in the first layer consist of a central pigment of micrometric dimension onto which a plurality of pigments of nanometric dimension are chemically grafted at the periphery;
the binder of the plurality of layers of the coating is a polymer;
the binder of the plurality of layers of the multilayer coating is an acrylic, an epoxy polymer or a polyurethane;
the pigments of the plurality of layers of the multilayer coating are carbon black;
the multilayer coating has a lightness component L* of less than 20;
the item is a timepiece component.

The invention further relates to a timepiece comprising such a timepiece component.

### BRIEF DESCRIPTION OF THE FIGURES

The purposes, advantages and features of the present invention will be better understood upon reading the detailed description given below with reference to the following figures:

FIG. 1 diagrammatically shows a cross-sectional view of a first example embodiment of an item, such as a timepiece component, comprising a substrate and a coating that absorbs visible light according to the invention;

FIG. 2 diagrammatically shows a cross-sectional view of a second example embodiment of an item, such as a timepiece component, comprising a substrate and a coating that absorbs visible light according to the invention;

FIG. 3 diagrammatically shows a cross-sectional view of a third example embodiment of an item, such as a timepiece component, comprising a substrate and a coating that absorbs visible light according to the invention;

FIG. 4 illustrates an example embodiment of an item according to the invention.

### DETAILED DESCRIPTION OF THE INVENTION

In the present description, the colorimetric properties of the light-absorbing coating obtained according to the method for depositing a coating according to the invention are expressed using the CIE L*a*b* colour space and measured according to the CIE 1976 standard on polished samples with a KONICA MINOLTA CM-3610-A spectrophotometer, with the following parameters: illumination source CIE D65 (daylight 6500° K), 10° tilt, SCI measurements (including specular reflection), measurement zone 4 mm in diameter.

A CIELAB colour space (in accordance with CIE standard no. 15, ISO 7724/1, DIN 5033 Teil 7, ASTM E-1164) has a lightness component L*, representative of the way in which the material reflects light, assimilated to lightness, with an a* component which is the green/red component and a b* component which is the blue/yellow component.

In the present application, the size of the particles and pigments is characterised in relation to the d90 value of a particle size distribution. In a particle size distribution, the use of the d90 percentile means that at least 90% of the particles or pigments from all of the particles used have a size below the d90 value.

### First Example Embodiment

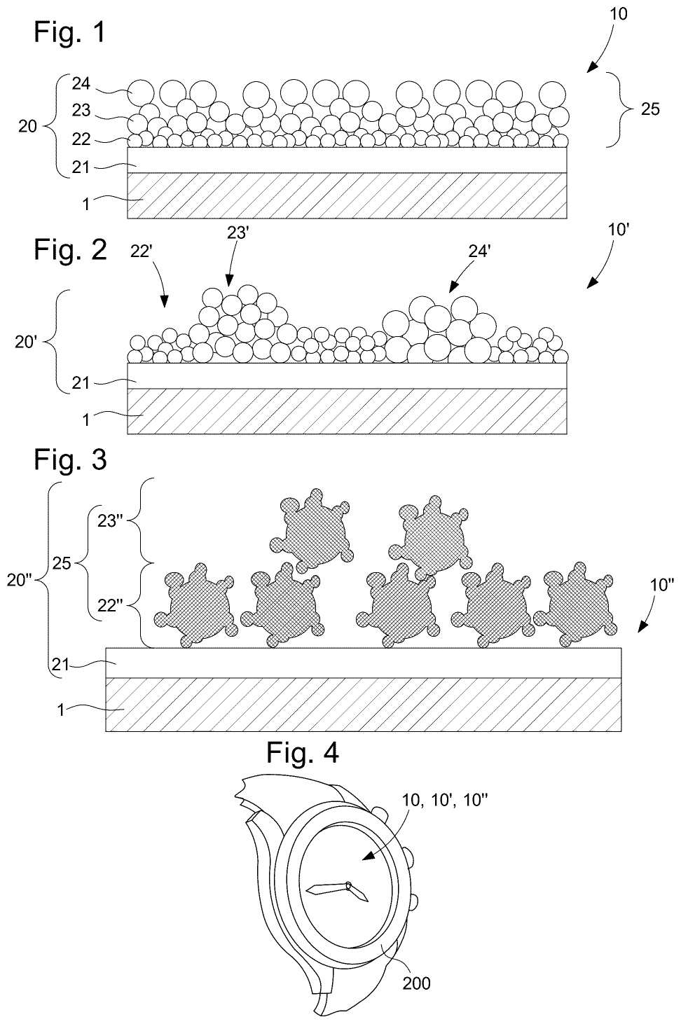

FIG. 1 diagrammatically shows a cross-sectional view of a first example embodiment of an item 10, such as a timepiece component, comprising a substrate 1 and a visible light-absorbing coating 20 covering at least a portion of the substrate 1 by means of the deposition method 100 according to the invention. Such a light-absorbing coating 20 according to the invention forms a multilayer structure comprising pigments with a particle size that varies between the layers, preferably increasing as the number of layers increases.

Preferably, the density of the pigments between the various layers of the coating 20 is also variable, preferably decreasing as the number of layers increases.

The item 10 is, for example, a timepiece component, for example a plate, a cock, a wheel, a screw, an oscillating weight, a dial, an index, an applique, an aperture disc, a hand or any other component or member of a horological movement or of an external component of a timepiece, that is intended to have an impression of deep and intense colour, without light reflection, with a lightness component L* of less than 20.

FIG. 3 illustrates a timepiece 200 comprising an item 10 according to the invention. In this example embodiment, the item 10 according to the invention is a dial.

The substrate 1 can be of any nature, for example it can be made of a metal, polymer, ceramic or even composite material.

The item 10 comprises a non-uniform coating 20 with a clarity component L* of less than 20 with various substrates. By way of comparison, a coating method using physical vapour deposition (PVD) of a uniform thin film cannot be used to produce a coating with a lightness component L* of less than 20 because of the topology of the layers deposited. With PVD, the lightness component L* of a matt coating is between 25 and 30.

The particular multilayer structure of the light-absorbing coating 20 according to the invention makes it possible to avoid reflection phenomena with the visible surface of the coating. The coating 20 also allows light to be scattered in the structure created by the differences in particle size of the pigments that make up the coating until it is trapped, so as to obtain maximum light absorption.

The coating 20 comprises an undercoat 21 forming a base layer, configured to cover the substrate 1, at least over a portion of the substrate 1.

Preferably, the undercoat 21 completely covers at least one surface of the substrate 1.

The undercoat 21 has a thickness sufficient to ensure that it is homogeneous and opaque and that the optical interference from the substrate 1 is no longer active. For example, the undercoat 21 has a thickness equal to or greater than 1 μm and less than 20 μm, and more preferably a thickness of between 5 μm and 10 μm.

Preferably, the undercoat 21 is formed by depositing a first liquid mixture on the substrate 1, which mixture comprises a binder, pigments and a solvent, the solvent evaporating as the first liquid mixture dries, the binder shrinking around the pigments, thus creating the undercoat 21 of the coating 20.

For example, the undercoat is formed by depositing a first liquid mixture comprising 30 to 40% by weight of binder, 50 to 60% by weight of solvent and from 5 to 10% by weight of pigments.

For example, the undercoat is formed by depositing a first liquid mixture consisting of 30% by weight of acrylic binder, 60% by weight of solvents and 10% by weight of Emperor® 1600 carbon black pigments.

Optionally, the undercoat 21 can further include a matting agent, for example a nanosilica, to further accentuate the intensity of the coating 20.

Optionally, the undercoat 21 can further include a dispersing agent to help suspend the pigments in the liquid mixture.

Preferably, the binder of the undercoat 21 is a polymer, for example an acrylic, an epoxy polymer or a polyurethane.

For example, the undercoat 21 is formed by applying a coloured ink.

For example, the undercoat 21 is formed by applying a black ink containing carbon black pigments.

The undercoat 21 is formed by sputtering, spraying, dipping, screen printing, printing or pad printing the first liquid mixture onto the substrate 1.

Preferably, the pigments in the undercoat 21 have a d90 percentile of nanometric dimension, for example between 20 and 120 nm, preferably less than 100 nm. Thus, the undercoat 21 is a homogeneous layer with a low roughness.

The undercoat 21 is covered by a stack 25 of a plurality of layers 22, 23, 24 superimposed on one another, each layer of the stack 25 having pigments with a d90 percentile different from the d90 percentile of the pigments in the layer it covers.

Preferably, the stack 25 has pigments distributed according to a d90 percentile which increases from the substrate towards the surface of the coating 20. Thus, each layer of the stack 25 has pigments with a d90 percentile greater than the pigments in the layer it covers.

Preferably, each layer n of the stack 25 has pigments with a d90 percentile equivalent to n*k/10 μm, where k is a homothetic factor between the d90 percentile of the pigments in the layer n−1 previously deposited and the d90 percentile of the pigments in the layer n to be deposited, i.e. between two consecutive layers of the stack 25.

Preferably, the homothetic factor is between 5 and 1000.

In the example embodiment shown in FIG. 1, the stack 25 comprises three layers 22, 23, 24 deposited successively. It goes without saying that the stack 25 can comprise at least two successive layers or more than three successive layers to form the particular structure of the stack 25 covering the undercoat 21.

The first layer 22 of the stack 25 comprises pigments with a d90 percentile greater than the d90 percentile of the pigments in the undercoat 21, for example of micrometric size and less than 20 μm, preferably of the order of 15 μm.

The second layer 23 of the stack 25 at least partially covering the first layer 22 of the stack 25 comprises pigments with a d90 percentile, for example, of the order of 80 μm.

The third layer 24 of the stack 25 at least partially covering the second layer 23 of the stack 25 comprises pigments with a size d90 percentile of the order of 250 μm, for example.

Each layer 22, 23, 24 is formed respectively by successively depositing a liquid mixture comprising a binder, pigments and a solvent, the d90 percentile of the pigments in the various liquid mixtures varying according to the aforementioned ratio to form the various layers with increasing particle size distribution, so as to increase the overall roughness of the coating.

After each mixture has been applied by sputtering, spraying, dipping, screen printing, printing or pad printing, the solvent evaporates to allow polymerisation and shrinkage of the binder around the pigments, thus forming a solid layer at least partially covering the previous layer or the undercoat 21, the new layer having a roughness greater than that of the previous layer.

Preferably, the binder and the nature of the pigments in the various layers 22, 23, 24 of the stack 25 are identical.

Optionally, the layers 22, 23, 24 of the stack 25 can include a matting agent, for example a nanosilica, to further accentuate the intensity of the stack 25 and more generally of the coating 20.

Optionally, the layers 22, 23, 24 of the stack 25 can include glass beads to further increase the roughness of the stack. Preferably, the glass beads are used in the final layer of the stack 25.

Optionally, the layers 22, 23 and 24 of the stack 25 can include a dispersing agent to help suspend the pigments in the first liquid mixture.

Preferably, the binder in the layers 22, 23, 24 forming the stack 25 is a polymer, for example an acrylic, an epoxy polymer or a polyurethane.

For example, the layers 22, 23, 24 forming the stack 25 are formed by applying coloured inks.

Preferably, the binder, the nature of the pigments and the solvent used to form the layers of the stack 25 are identical to those used to produce the undercoat 21.

The pigments used to form the layers of the stack 25 can also be of a different nature to the pigments used to produce the undercoat 21.

Preferably, the density of the pigments in the various layers 22, 23, 24 is variable.

Preferably, the density of the pigments in the layers 22, 23, 24 of the stack 25 lowers as the size d90 percentile of the pigments increases in the layers 22, 23, 24.

For example, the first layer 22 of the stack 25 is made from a liquid mixture containing between 4 and 10% by weight of pigments, preferably between 4 and 8% by weight of pigments.

For example, the second layer 23 of the stack 25 is made from a liquid mixture containing between 1 and 4% by weight of pigments.

For example, the third layer 24 of the stack 25 is made from a liquid mixture containing between 0.5 and 4% by weight of pigments, preferably between 0.5 and 1% by weight of pigments.

For example, the substrate 1 is made of brass, for example for forming a dial, to which a light-absorbing coating according to the invention is applied. The brass substrate is, for example, 0.27 mm thick.

The undercoat 21 is applied to the brass substrate by dipping in a first liquid mixture consisting of 2 g of polyurethane resin (Berlacryl), 0.5 g of Emperor 1600 carbon black pigments and 2.8 g of Berlaflex thinner. The layer is left to dry for 20 minutes to allow the thinner to evaporate.

The first layer 22 of the stack 25 is applied to the undercoat 21 by dipping in a second liquid mixture consisting of 2 g of polyurethane resin (Berlacryl), 0.3 g of Living Ink pigments and 3.5 g of Berlaflex thinner. The layer is left to dry for 20 minutes to allow the thinner to evaporate.

The second layer 23 of the stack 25 is applied to the first layer 22 by dipping in a third liquid mixture consisting of 2 g of polyurethane resin (Berlacryl), 0.2 g of Norit A ultra E153 pigments and 4 g of Berlaflex thinner. The layer is left to dry for 20 minutes to allow the thinner to evaporate.

The third layer 24 of the stack 25 is applied to the second layer 23 by dipping in a fourth liquid mixture consisting of 2 g of polyurethane resin (Berlacryl), 0.2 g of Norit SX super E153 carbon pigments, 1.5 g of 90-150 μm glass beads and 4 g of Berlaflex thinner. The layer is left to dry for 20 minutes to allow the thinner to evaporate.

Such a coating 10 produces a brass dial with a black surface coating and a lightness component L* of 15.9.

### Second Example Embodiment

FIG. 2 diagrammatically shows a cross-sectional view of a second example embodiment of an item 10′, such as a timepiece component, comprising a substrate 1 and a decorative coating 20 with visible light absorption properties.

The coating 20′ covers at least a portion of the substrate 1. In this second example embodiment, the coating 20′ according to the invention forms a non-uniform structure composed of multi-zones with variable roughness, the different zones of the coating having pigments with different particle sizes.

Preferably, the density of the pigments between the various zones of the coating 20′ is also variable, preferably decreasing as the size of the pigments increases.

The item 10′ is, for example, a timepiece component, for example a plate, a cock, a wheel, a screw, an oscillating weight, a dial, an index, an applique, an aperture disc, a hand or any other component or member of a horological movement or of an external component of a timepiece, that is intended to have an impression of deep and intense colour, without light reflection, with a lightness component L* of less than 20.

The multi-zone structure of the coating 20′ according to the invention makes it possible to create patterns by varying the different levels of visible light absorption. Preferably, the multi-zone structure of the coating 20′ according to the invention makes it possible to create monochrome patterns with different levels of visible light absorption.

The coating 20′ comprises an undercoat 21 forming a base layer, configured to cover the substrate 1, at least over a portion of the substrate 1. This undercoat 21 is identical to the undercoat described previously with reference to FIG. 1.

The multi-zone structure of the coating 20′ is formed by a plurality of juxtaposed layers which respectively cover a defined portion of the undercoat 21.

The undercoat 21 is covered by a first layer 22′ at a first defined portion of the undercoat 21. The first layer 22′ has pigments with a d90 percentile greater than the d90 percentile of the pigments in the undercoat 21.

The undercoat 21 is also covered by a second layer 23′ at a defined second portion of the undercoat 21, this second portion being different from the first portion covered by the first layer 22′. This second portion may or may not be juxtaposed to the first portion.

The second layer 23′ has pigments with a d90 percentile greater than the d90 percentile of the pigments in the first layer 22.

The undercoat 21 can also be covered by other layers at various specific portions of the undercoat 21 to create a particular pattern with particular optical features and varying levels of light absorption depending on the size of pigments used.

For the purposes of illustration, the example embodiment shown in FIG. 2 comprises a third layer 24′ deposited locally on the undercoat 21 at a defined third portion. This third portion is different from the first portion covered by the first layer 22′ and from the second portion covered by the second layer 23′. This third portion can be juxtaposed to the first portion and/or to the second portion. Under no circumstances are these various layers applied to the undercoat 21 superimposed on one another.

The third layer 24′ has pigments with a d90 percentile greater than the d90 percentile of the pigments in the second layer 23′.

By way of example, the pigments in the layers 22′, 23′, 24′ covering the undercoat 21 have micrometric dimensions.

By way of example, the first layer 22′ comprises pigments with a d90 percentile of micrometric size and less than 20 μm, for example of the order of 15 μm.

By way of example, the second layer 23′ comprises pigments with a d90 percentile of between 20 μm and 100 μm, preferably of the order of 80 μm.

By way of example, the third layer 24′ comprises pigments with a d90 percentile of between 100 μm and 300 μm, preferably of the order of 250 μm.

Each layer 22′, 23′, 24′ partially covering the undercoat 21 is formed respectively by depositing a liquid mixture through one or more masks applied to the undercoat 21 so as to mask certain zones and reveal other zones intended to receive a layer with a predetermined particle size.

Each layer 22′, 23′, 24′ partially covering the undercoat 21 is formed respectively by depositing a liquid mixture comprising a binder, pigments and a solvent, the d90 percentile of the pigments in the different liquid mixtures varying between the various layers.

Each layer 22′, 23′, 24′ partially covering the undercoat 21 is formed respectively by depositing a liquid mixture by sputtering, spraying, dipping, screen printing, printing or pad printing.

After each mixture has been applied to the undercoat 21, the solvent evaporates to allow the binder to polymerise and shrink around the pigments, thus forming the various layers with different particle sizes.

Preferably, the binder and the nature of the pigments in the various layers 22′, 23′, 24′ are identical.

Optionally, the various layers of the coating 20 can include a matting agent, for example a nanosilica, to further accentuate the intensity of the coating 20.

Optionally, the various layers of the coating 20 can include glass beads to further increase the roughness of the stack.

Preferably, the binder in the various layers of the coating 20′ is a polymer, for example an acrylic, an epoxy polymer or a polyurethane.

For example, the various layers of the coating 20 are formed by applying coloured inks, for example black inks containing carbon black as a pigment.

Preferably, the binder and the nature of the pigments in the various layers of the coating 20′ are identical.

However, the pigments in the various layers of the coating 20′ can be different in nature between the various layers and compared to the pigments in the undercoat 21.

The density of the pigments between the various layers 22′, 23′, 24′ can be variable, preferably decreasing as the size of the pigments increases.

For example, the first layer 22′ is made from a liquid mixture containing between 4 and 10% by weight of pigments, preferably between 4 and 8%.

For example, the second layer 23′ is made from a liquid mixture containing between 1 and 5% by weight of pigments, preferably between 1 and 4%.

For example, the third layer 24′ is made from a liquid mixture containing between 0.5 and 4% by weight of pigments, preferably between 0.5 and 1%.

By way of example, the substrate 1 is made of brass, for example for forming a dial, to which a light-absorbing coating according to the invention is applied. The brass substrate 1 is, for example, 0.27 mm thick.

The undercoat 21 is applied to the brass substrate by dipping in a first liquid mixture consisting of 2 g of polyurethane resin (Berlacryl), 0.5 g of Emperor 1600 carbon black pigments and 2.8 g of Berlaflex thinner. The layer is left to dry for 20 minutes to allow the thinner to evaporate.

The first layer 22′ is applied to the undercoat 21 through a first selective mask by dipping in a second liquid mixture consisting of 2 g of polyurethane resin (Berlacryl), 0.3 g of Living Ink pigments and 3.5 g of Berlaflex thinner. The layer is left to dry for 20 minutes to allow the thinner to evaporate.

The second layer 23′ is applied to the undercoat 21 through a second selective mask by dipping in a third liquid mixture consisting of 2 g of polyurethane resin (Berlacryl), 0.2 g of Norit A ultra E153 pigments and 4 g of Berlaflex thinner. The layer is left to dry for 20 minutes to allow the thinner to evaporate.

The third layer 24′ is applied to the undercoat 21 through a third selective mask by dipping in a fourth liquid mixture consisting of 2 g of polyurethane resin (Berlacryl), 0.2 g of Norit SX super E153 carbon pigments, 1.5 g of 90-150 μm glass beads and 4 g of Berlaflex thinner. The layer is left to dry for 20 minutes to allow the thinner to evaporate.

Such a coating 10′ produces a brass dial with a black surface coating and a lightness component L* of 16.

### Third Example Embodiment

FIG. 3 diagrammatically shows a cross-sectional view of a third example embodiment of an item 10″, such as a timepiece component, comprising a substrate 1 and a decorative coating 20″ with visible light absorption properties.

The coating 20″ covers at least a portion of the substrate 1. Such a coating 20″ according to the invention forms a non-uniform structure comprising agglomerates of pigments of different particle sizes. The coating 20″ can comprise a plurality of stacked layers containing these pigment agglomerates.

The density of the pigment agglomerates between the various layers of the coating 20″ can also be variable, preferably decreasing as the number of layers increases.

This third example structure of the coating 20″ is substantially equivalent to the structure of the coating 20 described with reference to FIG. 1, except that the layers comprise agglomerates composed of a plurality of pigments of different particle sizes.

The non-uniform structure of the coating 20″ prevents reflection phenomena with the visible surface of the coating. The coating 20″ also allows light to be scattered in the non-uniform structure created by the different agglomerates of pigments of different particle sizes and optionally by the variations in density of these agglomerates between the various superimposed layers. As a result, the light is trapped as much as possible, resulting in high light absorption.

The coating 20″ comprises an undercoat 21 forming a base layer, configured to cover the substrate 1, at least over a portion of the substrate 1. This undercoat 21 is identical to the undercoat described previously with reference to FIG. 1.

The undercoat 21 is covered, at least partially, by a first layer 22″. This second layer 22″ can form part of a stack 25 of a plurality of layers superimposed one on top of the other, the stack 25 at least partially covering the undercoat 21.

The first layer 22 is formed by depositing, on the undercoat 21, a formulation comprising a binder, agglomerates of pigments dispersed in the binder, a solvent and a coupling agent.

Once the formulation has been applied to the undercoat 21, the solvent evaporates and the binder shrinks around the pigment agglomerates, creating the first layer 22″ of the coating 20″.

The first layer 22″ is made up of a plurality of pigment agglomerates composed of a mixture of pigments with different particle sizes.

Preferably, the first layer 22″ consists of pigment agglomerates composed of the mixture of pigments having a d90 percentile of nanometric dimension and of pigments having a d90 percentile of micrometric dimension.

Preferably, the pigment agglomerates of the first layer 22″ are composed of a central pigment of micrometric dimension onto which is chemically grafted (by the coupling agent of the formulation) a plurality of pigments of nanometric dimensions, the nanometric pigments being coupled at the periphery of the central pigment.

The coupling agent will allow a strong chemical interaction to take place between the different pigments.

Optionally, the first layer 22″ can include a matting agent, for example a nanosilica, to further accentuate the intensity of the coating 20″.

Preferably, the formulation forming the first layer 22 comprises between 4 and 8% by weight of pigment agglomerates in the formulation.

Preferably, the binder of the first layer 22″ is a polymer, for example an acrylic, an epoxy polymer or a polyurethane. For example, the binder is identical to the binder in the undercoat 21.

For example, the first layer 22″ is formed by applying a coloured ink.

For example, the first layer 22″ is formed by applying a black ink containing carbon black pigments.

For example, the coupling agent for the formation of pigment agglomerates in the formulation is a silane.

The first layer 22″ is formed by sputtering, spraying, dipping, screen printing, printing or pad printing the formulation onto the undercoat 21.

As shown by way of example in FIG. 3, the coating 20 can comprise a second layer 23″ at least partially covering the first layer 22″. This second layer 23″ forms a second layer of the stack 25, which stack can comprise a plurality of layers.

This second layer 23″ is also made up of a plurality of pigment agglomerates composed of a mixture of pigments with different particle sizes.

Preferably, the second layer 23″ consists of pigment agglomerates composed of the mixture of pigments having a d90 percentile of nanometric dimension and of pigments having a d90 percentile of micrometric dimension.

Preferably, the pigment agglomerates of the second layer 23″ are composed of a central pigment of micrometric dimension onto which is chemically grafted a plurality of pigments of nanometric dimensions, the nanometric pigments being coupled at the periphery of the central pigment.

Preferably, the d90 percentile of the pigments in the agglomerates of the second layer 23″ is identical to the d90 percentile of the pigments making up the agglomerates of the first layer 22″.

Optionally, the second layer 22″ can include a matting agent, for example a nanosilica, to further accentuate the intensity of the coating 20″.

Preferably, the formulation forming the second layer 23″ comprises between 1% and 4% by weight of pigments in the formulation.

Preferably, the second layer 23″ has a lower percentage by weight of agglomerates than the percentage by weight of agglomerates in the first layer 22″.

Preferably, the binder of the second layer 23″ is a polymer, for example an acrylic, an epoxy polymer or a polyurethane. Preferably, the binder in the various layers of the stack 25 is identical.

For example, the second layer 23″ is formed by applying a coloured ink.

For example, the second layer 23″ is formed by applying a black ink containing carbon black pigments.

The second layer 22″ is formed by sputtering, spraying, dipping, screen printing, printing or pad printing the formulation onto the first layer 22″.

By way of example, the substrate 1 is made of brass, for example for forming a dial, to which a light-absorbing coating 10″ according to the invention is applied. The brass substrate is, for example, 0.27 mm thick.

The undercoat 21 is applied to the brass substrate by dipping in a first formulation consisting of 2 g of polyurethane resin (Berlacryl), 0.5 g of Emperor 1600 carbon black pigments and 2.8 g of Berlaflex thinner. The first layer 21 is left to dry for 20 minutes to allow the thinner to evaporate.

The pigment agglomerates making up the second solution are prepared beforehand from a solution of isopropyl alcohol containing 5% organosilane (e.g. Methoxysilane), suspending the microsized pigments and the nanosized pigments. The solution is dried and the agglomerate powder recovered.

The first layer 22″ of the coating 20″ is applied to the undercoat 21 by dipping in a second formulation consisting of 2 g of polyurethane resin (Berlacryl), 0.3 g of agglomerate powder and 2.8 g of Berlaflex thinner. The second layer 22 is left to dry for 20 minutes to allow the thinner to evaporate.

Such a coating 20″ produces a brass dial with a black surface coating and a lightness component L* of 16.

1. An item comprising a substrate and a multilayer coating deposited on the substrate, wherein the multilayer coating is formed by combining a plurality of layers comprising a binder and pigments, the coating comprising pigments of different particle sizes.

2. The item according to claim 1, wherein said multilayer coating comprises pigments of nanometric and micrometric dimensions.

3. The item according to claim 2, wherein said multilayer coating comprises glass beads.

4. The item according to claim 1, wherein said multilayer coating comprises an undercoat covering at least a portion of the substrate, the undercoat comprising pigments with a d90 percentile of nanometric dimension.

5. The item according to claim 1, wherein said multilayer coating comprises a stack of a plurality of successive layers, superimposed on one another, at least partially covering the undercoat, each of the successive layers of the stack comprising pigments with a d90 percentile different from the d90 percentile of the pigments in the layer which it covers.

6. The item according to claim 5, wherein each of the successive layers in the stack comprises pigments with a d90 percentile greater than the d90 percentile of the pigments in the layer it covers.

7. The item according to claim 6, wherein each layer n of the stack has pigments with a d90 percentile equivalent to n*k/10 μm, where k is a homothetic factor between the d90 percentile of the pigments in two consecutive layers of the stack.

8. The item according to claim 1, wherein the multilayer coating comprises a plurality of layers of different particle sizes, which layers are juxtaposed relative to one another and which each cover a predetermined portion of the undercoat.

9. The item according to claim 8, wherein the pigments in the plurality of layers covering the undercoat are micrometric in size.

10. The item according to claim 8, wherein the multilayer coating comprises a first layer at least partially covering a first portion of the undercoat and a second layer juxtaposed to the first layer and at least partially covering a second portion of the undercoat, which portion is different from the first portion, the pigments of the second layer having a d90 percentile greater than the d90 percentile of the pigments in the first layer.

11. The item according to claim 1, wherein said multilayer coating comprises a first layer at least partially covering the undercoat, the first layer comprising pigment agglomerates composed of a mixture of pigments of different particle sizes.

12. The item according to claim 11, wherein the first layer comprises pigment agglomerates composed of the mixture of pigments having a d90 percentile of nanometric dimension and of pigments having a d90 percentile of micrometric dimension.

13. The item according to claim 11, wherein the pigment agglomerates in the first layer consist of a central pigment of micrometric dimension onto which a plurality of pigments of nanometric dimension are chemically grafted at the periphery.

14. The item according to claim 1, wherein the binder of the plurality of layers of the multilayer coating is a polymer.

15. The item according to claim 14, wherein the binder of the plurality of layers of the coating is an acrylic, an epoxy polymer or a polyurethane.

16. The item (according to claim 1, wherein the pigments of the plurality of layers of the multilayer coating are carbon black.

17. The item according to claim 1, wherein the multilayer coating has a lightness component L* of less than 20.

18. The item according to claim 1, wherein said item is a timepiece component.

19. A timepiece, comprising the timepiece component according to claim 18.
